(19) United States
(12) Patent Application Publication
(10) Pub. No.: US 2005/0177652 A1
(43) Pub. Date: Aug. 11, 2005

(54) Hard disk drive system, method of using such a system and apparatus

(76) Inventors: Stephen Rodney Cumpson, Eindhoven (NL); Filip Dominique Francois Ponsaerts, Hasselt (BE); Lambert Hubert Augustin Jacobs, Hasselt (BE)

Correspondence Address: PHILIPS INTELLECTUAL PROPERTY & STANDARDS, P.O. BOX 3001, BRIARCLIFF MANOR, NY, 10510, US

(21) Appl. No.: 10/513,943

(22) PCT Filed: Apr. 22, 2003
(86) PCT No.: PCT/IB03/01568

(51) Int. Cl. G06F 13/10

(52) U.S. Cl. 710/15

(57) ABSTRACT

A system for hard disk drives that prevents the host from receiving an unrecoverable error whilst reading an erroneous track or sector resulting from a sudden power failure, i.e. from an unexpected power removal. The system has to behave in real-time, therefore a known lengthy error recovery procedure is not acceptable. According to the invention the solution saves the status information, and possibly the data, of the hard disk drive system in a non-volatile memory. Thus the status information, and possibly data, is still available when the system is restarted. The non-volatile memory might be a magnetic (MRAM), a battery-backed static (SRAM) or a Ferro-electric random access memory (FeRAM). The invention is especially used for audio/video hard disk drive systems such as personal video recorders (PVR) or set-top boxes with storage capabilities. The embodiment which has the data stored in a non-volatile memory improves the data reliability of the system and can thus also be used for PC applications.

The invention relates to a hard disk drive system that prevents the host of a computer from receiving an unrecoverable error whilst reading an erroneous track or sector resulting from a sudden power failure, i.e. an unexpected power removal. When the hard disk system is shut down conventionally all necessary information is written to the sectors and tracks, whereas when a sudden power failure occurs the necessary information is not completely written to the sectors or tracks. At some time in the future this specific track or sector will be accessed again. However, reading this track or sector will result in an unrecoverable error, as the information is not completely written to it. When any kind of error occurs, a known error recovery procedure will usually be started. This will take multiple seconds. When the hard disk system is used in consumer equipment such as an audio/video application, a break of multiple seconds is not acceptable as it would generally be visible to the viewer. Therefore, these systems require the hard disk drive to behave in real-time.

U.S. Pat. No. 5,787,460 relates to a disk array apparatus in which a plurality of disk apparatuses are accessed in parallel and data input/output processes are executed and, more particularly, relates to a disk array apparatus for the efficient formation of redundant information when updating data stored in a disk apparatus. Disk arrays are high performance systems using multiple hard disk drive (HDD) units plus a controller system to provide increased performance and/or data reliability. A disk array apparatus almost guarantees data reliability, as the data are stored redundantly, i.e. the data are stored on at least two parallel hard disk drives. Thus, a disk array apparatus is expensive.

One object of the invention is to provide a hard disk drive system that prevents errors resulting from a power failure during a write operation.

The object of the invention is reached by a system for operating a hard disk drive comprising a hard disk drive, a host, a control circuitry, a random access memory (RAM) and a bidirectional connection between the hard disk drive and the host that has a partially or completely non-volatile RAM and is conceived to store status information of the hard disk drive, commands generated and transmitted by a host and/or data.

Conventional hard disk drive systems have a cache memory in which data from the host system is stored before being written to the disk drive. This conventional cache memory is a volatile memory, e.g. dynamic random access memory (DRAM). When a sudden power failure occurs, data in the cache is lost. Furthermore, the status of the hard disk drive processes is lost. This may result in corrupted data in sectors (wrong data, wrong error correction code) and in data loss.

Storing hard disk drive status information in the non-volatile RAM enables the system to first refer to the non-volatile RAM and check whether the system had been shut down conventionally or by a sudden power failure when the system is started. During normal operation, when the hard disk drive is requested to reproduce the contents stored on the disk, the host tries to read data from the hard disk drive, which can also first refer to the status information stored in the non-volatile RAM to check whether the next sector/track is erroneous. According to the invention an indication of a sudden power failure is that the confirmation of a correct and complete writing of information to the hard disk drive is missing. Another indication of the fact that the write-command has not been fully executed before the drive power failed is a bad error correction code byte (ECC). If the status information in the non-volatile memory indicates that the system has not been shut down correctly, the hard disk drive system offers different solutions for the continued procedure according to different embodiments referred to hereinafter.

The use of a battery-backed memory for the non-volatile RAM ensures that content is retained during a power failure. According to the invention, content is the status information of the hard disk drive, commands generated and transmitted by a host and/or data. The advantage of using a magnetic random access memory (MRAM) is that the complete RAM could be non-volatile. As a magnetic random access memory (MRAM) can read/write faster than a conventional non-volatile memory, e.g. so-called flash memory, the reading/writing process of the non-volatile memory is fast enough for the hard disk drive system to finish the interrupted assignment that happened during power failure when the system power is restored. A static random access memory (SRAM) is a high-speed memory and thus advantageously increases the reliability of the operation, but requires a battery as a power source. A Ferro-electric random access memory (FeRAM) has a low power consumption and is therefore typically used in portable applications.

All the tracks or sectors of a hard disk drive have an address. The storing of the address of the last sector or track to which was written as status information in the non-volatile RAM would advantageously lead to the hard disk drive knowing in advance that this/these sector(s) or tracks are unreadable and being able to send an instant message to the host containing this information. This message would ideally be identical to that which would have been issued to the host if the full error recovery procedure had been executed, only immediately. In consequence, the hard disk drive system according to the invention improves the real-time drive performance as the host of a computer is prevented from receiving an unrecoverable error whilst reading an erroneous track or sector due to power failure during a write operation, whereas when the status information is stored in the hard disk drive system it contains a confirmation if the last physical disk access was correctly executed. This confirmation is initially sent to the host once a restart has been implemented.

According to the invention the hard disk drive system comprises a host that generates a list of commands. If the command refers to the hard disk drive it is sent to the same. The host and the hard disk drive are bidirectionally connected. The commands in the list are translated into jobs being performed. A further indication of a sudden power failure is the fact that the status of the process or processes is: “job-in-progress” or something similar. That means: the job or jobs is/are not correctly completed. Thus, the status information in the non-volatile RAM of the hard disk drive system contains a job-in-progress-information as long as the current command is not completely executed. Advantageously the status information “job-in-progress” is preserved in the non-volatile RAM during a power failure until the system has been restarted and longer.

The invention also provides a method of operating a hard disk drive system, especially a hard disk drive system comprising a hard disk drive, a host, a bidirectional connection between the hard disk drive and the host, a control circuitry and a partially or completely non-volatile random access memory (RAM) that is conceived to store status information of the hard disk drive, commands generated and transmitted by a host or data, that continues the interrupted job once power has been restored. This is possible if the non-volatile RAM is large enough to buffer data that are supposed to be written to disk until the requested job is finished.

According to the invention another method of operating a hard disk drive system generates and/or sends an instant message from the hard disk drive to the host when the host tries to read an erroneous track or sector. As described above the last addressed track or sector is stored in the non-volatile RAM. Combined with the job-in-progress-information or the missing confirmation, it enables the system to instantly generate the corresponding message. The host then stops the trial to read from the erroneous track or sector. The time period for generating the instant message is significantly shorter than multiple seconds. In a preferred embodiment the time period takes about 20 microseconds.

The invention also provides an apparatus comprising a host and a hard disk drive coupled by an interface comprising:
a partially or completely non-volatile RAM for storing status information of the hard disk drive, and commands from the host or data;
a tuner for generating an audio/video stream;
a monitor for displaying the audio/video stream and
a means of transmitting the audio/video stream to the monitor.

According to the invention the hard disk drive system comprising a partially or completely non-volatile random access memory (RAM) conceived to store status information of the hard disk drive, commands generated and transmitted by a host or data is advantageously used for an audio and/or video application with the effect that a sudden system power failure does not lead to a visible or audible break of the reproduction of data.

The invention is especially used for audio/video hard disk drive systems such as personal video recorders (PVR) or set-top boxes with storage capabilities. When the data is also available in the non-volatile RAM the invention improves data reliability and can also be used for PC applications.

Another advantage of the invention is that it can be integrated in a control circuit, using known processing that enables integration of standard logic and non-volatile memory into one integrated circuit.

These and other aspects of the invention will be apparent from and elucidated with reference to the embodiments described hereinafter, wherein

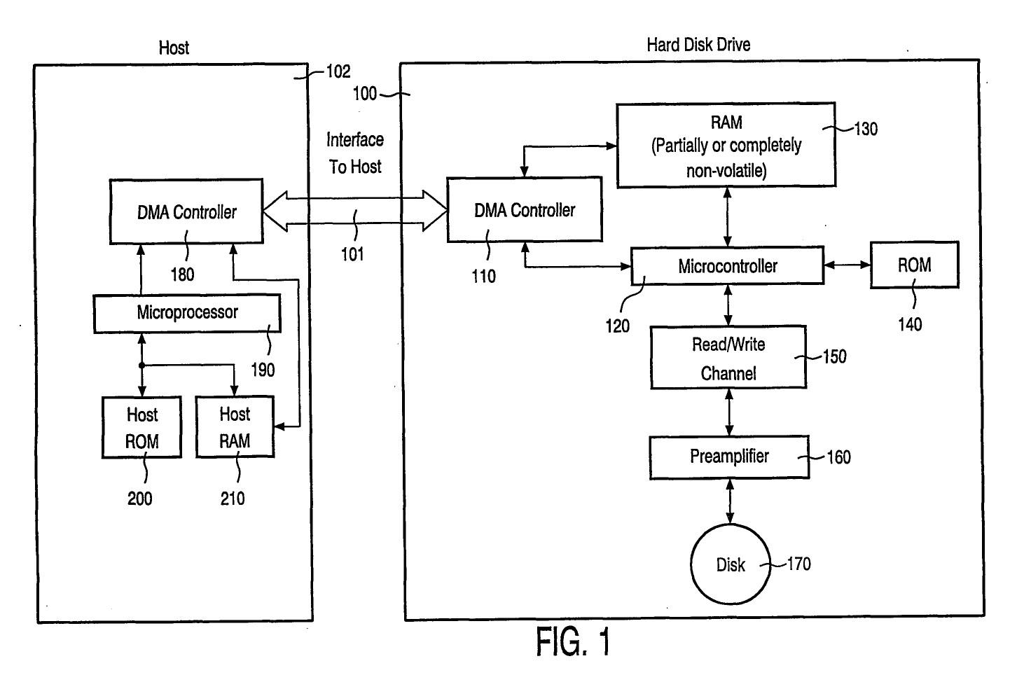

FIG. 1 shows a block diagram of the main hard disk drive system parts;

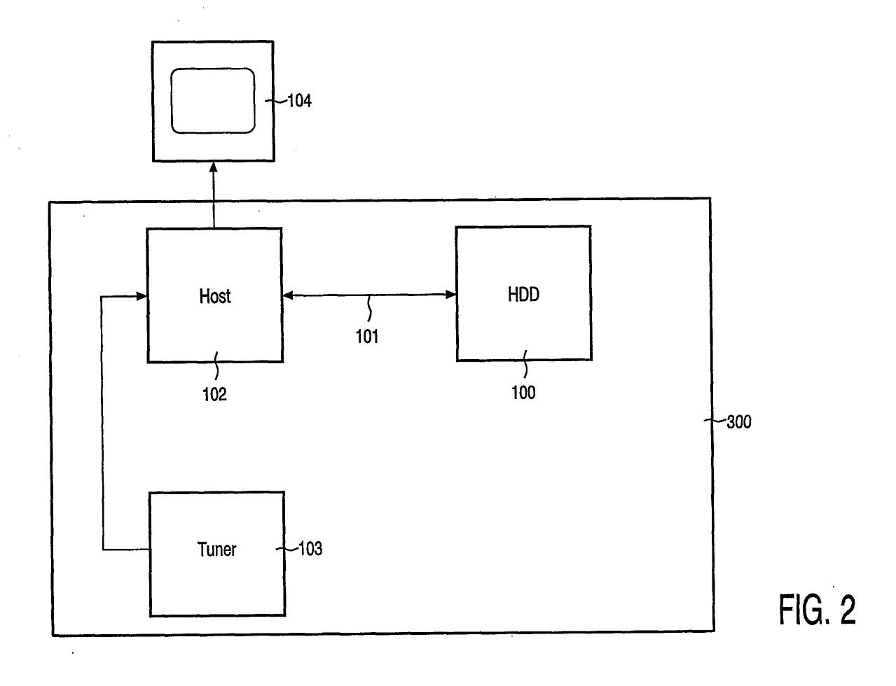

FIG. 2 shows an apparatus comprising the hard disk drive system that is coupled via an interface with a tuner providing the audio/video data and a monitor for displaying the real-time video stream.

FIG. 1 shows a block diagram of the main system parts of a hard disk drive system 100. The hard disk drive system 100 is coupled with the host 102 by an interface 101 and basically consists of a DMA controller 110, a microcontroller 120 and a RAM 130. The RAM 130 can either be partially or completely non-volatile. If the RAM 130 is only partially non-volatile it offers a limited amount of storage capacity, thus only the current status of hard disk drive system 100 can be stored. However, it allows immediate error reporting and improves the real-time performance as described above. In another embodiment the RAM 130 is completely non-volatile. In this case, the status and the buffer contents are preserved during a power failure. This allows immediate error correction once power has been restored, for improved real-time performance and at the same time increased data reliability.

Hard disk drive system 100 and host 102 are connected by a common interface. Both the hard disk drive 100 has the facility for a fixed boot code held in read only memory (ROM) for initialization 140. The host 102 may also have such provision 200. The host 102 may be a general purpose computer or an embedded system, such as a consumer electronics device. The host 102 uses the hard disk drive system 100 to preserve information during a power failure. The host 102 expects the hard disk drive system 100 to always perform the operation requested by the host 102 without errors. Any operation begins in the host system, in which an application runs on the microprocessor 190. When the host 102 becomes aware that a data transfer is required to or from the hard disk drive system 100, a host RAM 210 region is reserved for the data transfer. The host then sets up a DMA control table in the DMA controller 180 describing the reserved host memory 210 region. The final host 102 operation is to inform the hard disk drive system 100 of the requested data operation using a standard protocol via the common interface 101. Under normal operational conditions the hard disk drive system 100 attempts to perform the required data transfer in the shortest possible time and ensures that the data is read from or written to the reserved memory 210 region in the host 102. In the hard disk drive system 100 the information is stored on a magnetic disk 170. The signal is read using a magnetic read/write head and amplified by the preamplifier 160. The read/write channel 150 processes the signal to minimize the chance of an error. The microcontroller 120 in the hard disk drive system 100 controls the hard disk drive servo system and ensures that data is correctly transmitted and received via the common interface 101. The microcontroller 120 also uses buffering to improve average performance using a RAM 130. Finally, the microcontroller 120 is also responsible for correcting as many data errors as possible. According to the invention the RAM module 130 is modified to become a module that is partially or completely non-volatile.

FIG. 2 shows an apparatus 300 comprising the hard disk drive system 100 that is bidirectionally connected via an interface 101 to the host 102 and a tuner 103. This apparatus 300 forms part of a consumer electronic device such as a television receiver or a personal computer. The host 102 transmits the audio/video stream to a monitor 104.

The invention may be summarized by a hard disk drive system that prevents the host from receiving an unrecoverable error whilst reading an erroneous track or sector resulting from a sudden power failure, i.e. from an unexpected power removal. The system has to behave in real-time, therefore a known lengthy error recovery procedure is not acceptable. According to the invention the solution saves the status information, and possibly the data, of the hard disk drive system in a non-volatile memory. Thus the status information, and possibly data, is still available once the system is restarted. The non-volatile memory might be a magnetic (MRAM) a battery-backed static (SRAM) or a Ferro-electric random access memory (FeRAM) or any kind of other fast access non-volatile memory. The invention is especially used for audio/video hard disk drive systems such as personal video recorders (PVR) or set-top boxes with storage capabilities. The embodiment which has the data stored in a non-volatile memory improves the data reliability of the system and can thus also be used for PC applications.

1. System for operating a hard disk drive comprising a hard disk drive, a host, a control circuitry, a random access memory (RAM) and a bidirectional connection between the hard disk drive and the host, characterized in that the RAM is partially or completely non-volatile and conceived to store status information of the hard disk drive, commands generated and transmitted by a host and/or data.

2. System as claimed in claim 1, characterized in that the non-volatile RAM is selected from the group consisting of: battery-backed memory such as static random access memory (SRAM), magnetic random access memory (MRAM) or Ferro-electric random access memory (FeRAM).

3. System as claimed in claim 1, characterized in that the status information of the hard disk drive contains the address of the track or sector to which was last written.

4. Hard disk drive system as claimed in claim 1, characterized in that the status information contains a confirmation if the last physical disk access was correctly executed.

5. Hard disk drive system as claimed in claim 1, characterized in that the status information in the non-volatile RAM contains a job-in-progress-information as long as the current command is not completely executed.

6. Hard disk drive system as claimed in claim 1, characterized in that the job-in-progress-information is preserved in the non-volatile RAM during a power failure until the system has been restarted and beyond.

7. Method of operating a hard disk drive system, especially a hard disk drive system comprising a hard disk drive, a host, a bidirectional connection between the hard disk drive and the host, a control circuitry and a partially or completely non-volatile random access memory (RAM) that is conceived to store status information of the hard disk drive, commands generated and transmitted by a host or data, characterized in that the hard disk drive continues the interrupted job once power has been restored.

8. Method of operating a hard disk drive system, especially a hard disk drive system comprising a hard disk drive, a host, a bidirectional connection between the hard disk drive and the host, a control circuitry and a partially or completely non-volatile random access memory (RAM) that is conceived to store status information of the hard disk drive, commands generated and transmitted by a host or data, characterized in that an instant message is generated and/or sent by the hard disk drive to the host when the host tries to read an erroneous track or sector.

9. Apparatus for reproducing audio or visual data comprising a host and a hard disk drive that are coupled by an interface comprising:
a partially or completely non-volatile RAM for storing status information of the hard disk drive, commands from the host or data;
a tuner for generating an audio/video stream;
a monitor for displaying the audio/video stream and
a means of transmitting the audio/video stream to the monitor.

10. Use of a hard disk drive system comprising a hard disk drive, a host, a control circuit, a bidirectional connection between the hard disk drive and the host and a partially or completely non-volatile random access memory (RAM) that is conceived to store status information of the hard disk drive, commands generated and transmitted by a host or data for an audio and/or video application with the effect that a sudden system power failure does not lead to a visible or audible break in the reproduction of information.
